(19) United States
(12) Patent Application Publication
(10) Pub. No.: US 2004/0227722 A1
(43) Pub. Date: Nov. 18, 2004

(54) Article of manufacture for the protection of LCD flat screen monitors, TV's and portable computer display screens

(76) Inventors: Morris Kevin Friberg, Thornton, CO (US); Scott Andrew Friberg, Longmont, CO (US)

Correspondence Address: Morris Kevin Friberg, Unit D, 4230 E 94th Ave., Thornton, CO, 80229, US

(21) Appl. No.: 10/436,594

(22) Filed: May 12, 2003

(51) Int. Cl. G09G 5/00

(52) U.S. Cl. 345/156

(57) ABSTRACT

An article of manufacture for the improved protection of LCD flat screen monitors, TV's and portable computer display screens is disclosed having A screen protector, and An adhesive for attaching the screen protector to the monitor. In the preferred embodiment the screen protector is made of non-reflective glass and the adhesive is a permanent type of peel and stick.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of video displays, and more specifically to an article of manufacture for the protection of LCD flat screen monitors, TV's and portable computer display screens. Traditional computer monitors and TV's were designed around a Cathode Ray Tube. Inherent to this design is a picture tube with a thick glass viewing screen. This type of screen required no additional protection.

Today's flat screen monitors, TV's and portable computers are designed around a Liquid Crystal Display. Inherent to this design is a display screen which is easily damaged or ruined when touched.

Prior technologies for CRT monitors include an assortment of dust covers and glare reducing screens that are designed to protect the viewer, not the CRT monitor. These are attached with various types of brackets, clamps, Velcro and other bulky mounting systems.

The LCD flat screen technology is relatively new and has only recently become an economical replacement for the CRT monitor or TV.

The dust covers and glare protectors assocciated with CRT monitors have no application with LCD monitor technology as the LCD's generate no static electicity to gather dust and are glare free by design. Inherent to the LCD monitor design is their vulnerability to accidental or intentional damage of the display screen. While this is not an issue in most office enviroments it is for schools, libraries, industrial and other enviroments. The flat screen monitor protector disclosed in this application will prevent accidental damage, deter intentional damage and attach quickly, easily, and permanently without bulky or complicated mounting systems.

### BRIEF SUMMARY OF THE INVENTION

The primary object of the invention is to provide an article that protects LCD flatscreen monitors, TV's or portable computer's display screen.

Another object of the invention is to provide an article that protects LCD flatscreen monitors, TV's or portable computer's display screen from vandalism.

Another object of the invention is to provide an article that protects LCD flatscreen monitors, TV's or portable computer's display screen from impact.

A further object of the invention is to provide an article that protects LCD flatscreen monitors, TV's or portable computer's display screen from dust, dirt and finger prints.

Yet another object of the invention is to provide an article that protects LCD flatscreen monitors, TV's or portable computer's display screen from spills.

Still yet another object of the invention is to provide an article that protects LCD flatscreen monitors, TV's or portable computer's display screen from chemical spills.

Another object of the invention is to provide an article that protects LCD flatscreen monitors, TV's or portable computer's display screen that attaches easily.

Another object of the invention is to provide an article that protects LCD flatscreen monitors, TV's or portable computer's display screen that attaches quickly.

A further object of the invention is to provide an article that protects LCD flatscreen monitors, TV's or portable computer's display screen that attaches without screws.

Yet another object of the invention is to provide an article that protects LCD flatscreen monitors, TV's or portable computer's display screen that attaches without bulky fasteners.

Still yet another object of the invention is to provide an article that protects LCD flatscreen monitors, TV's or portable computer's display screen that attaches without clips.

Another object of the invention is to provide an article that protects LCD flatscreen monitors, TV's or portable computer's display screen that attaches without clamps.

Another object of the invention is to provide an article that protects LCD flatscreen monitors, TV's or portable computer's display screen that attaches with adhesive.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for the protection of LCD flat screen monitors, TV's and portable computer display screens comprising: A monitor screen protector, and An adhesive to attach the screen protector to the monitor.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1> is a plan view of the invention.

FIG. <2> is a perspective view of the invention ready to install on flat screen monitor, TV or portable computer display screen

FIG. <3> is a perspective view of the invention installed on flat screen monitor, TV or portable computer display screen

Reference Numerals in Drawings

10 Monitor Screen Protector

11 Adhesive

12 Flat screen monitor/TV or portable computer display screen

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

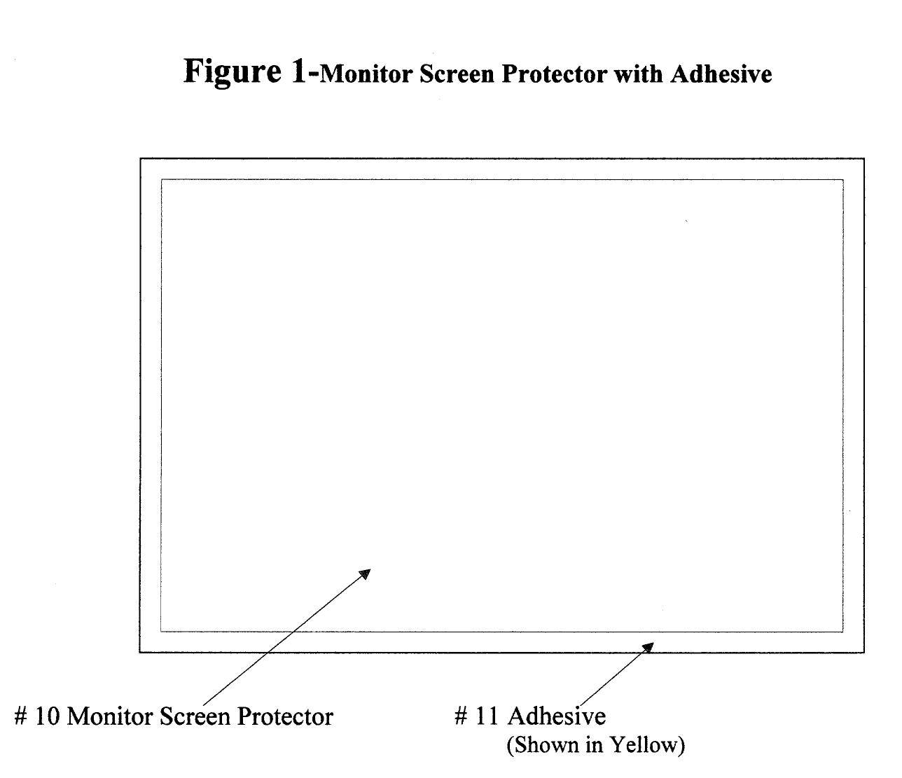

Description—FIGS. 1-3.

Turning first to FIG. 1 (plan view) there is shown #10-Monitor Screen Protector and #11-Adhesive. In the preferred embodiment, the Screen Protector is made of anti-reflective glass. The adhesive will be pre-applied to the screen protector during manufacture and provide a permanent peel and stick application method.

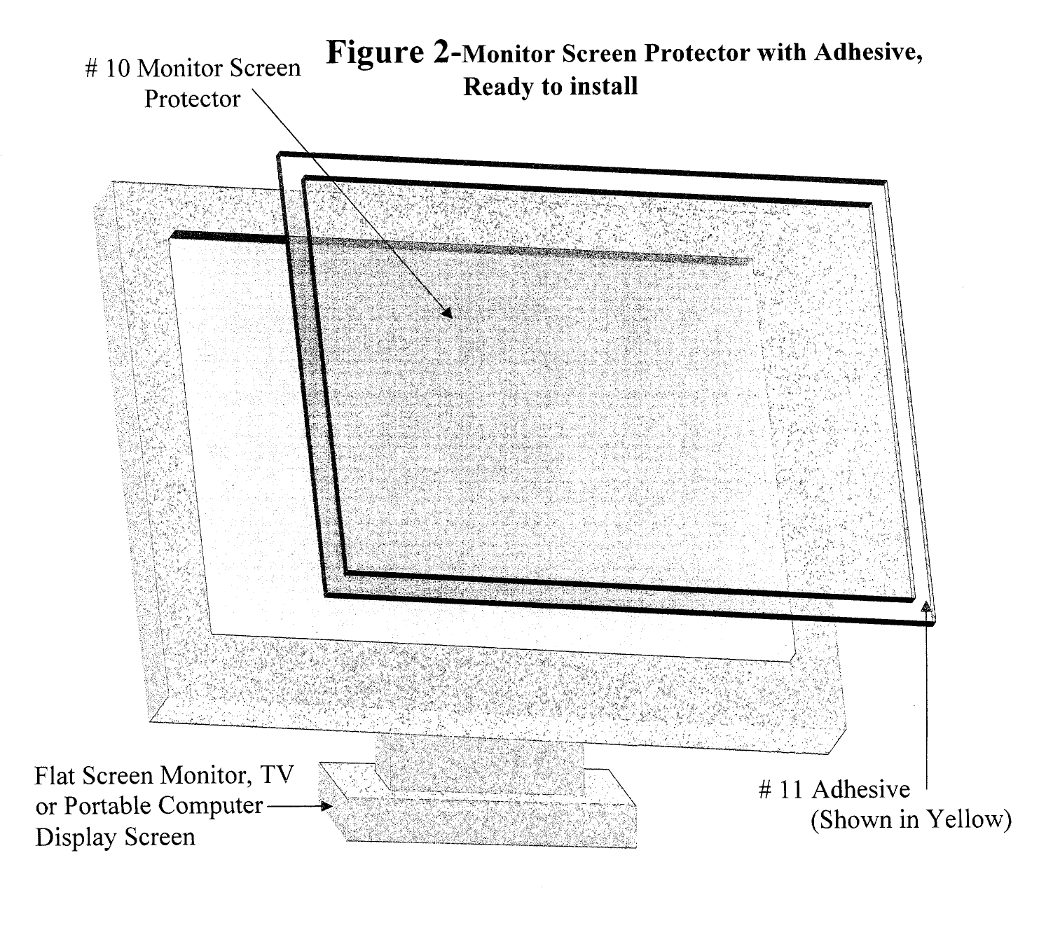

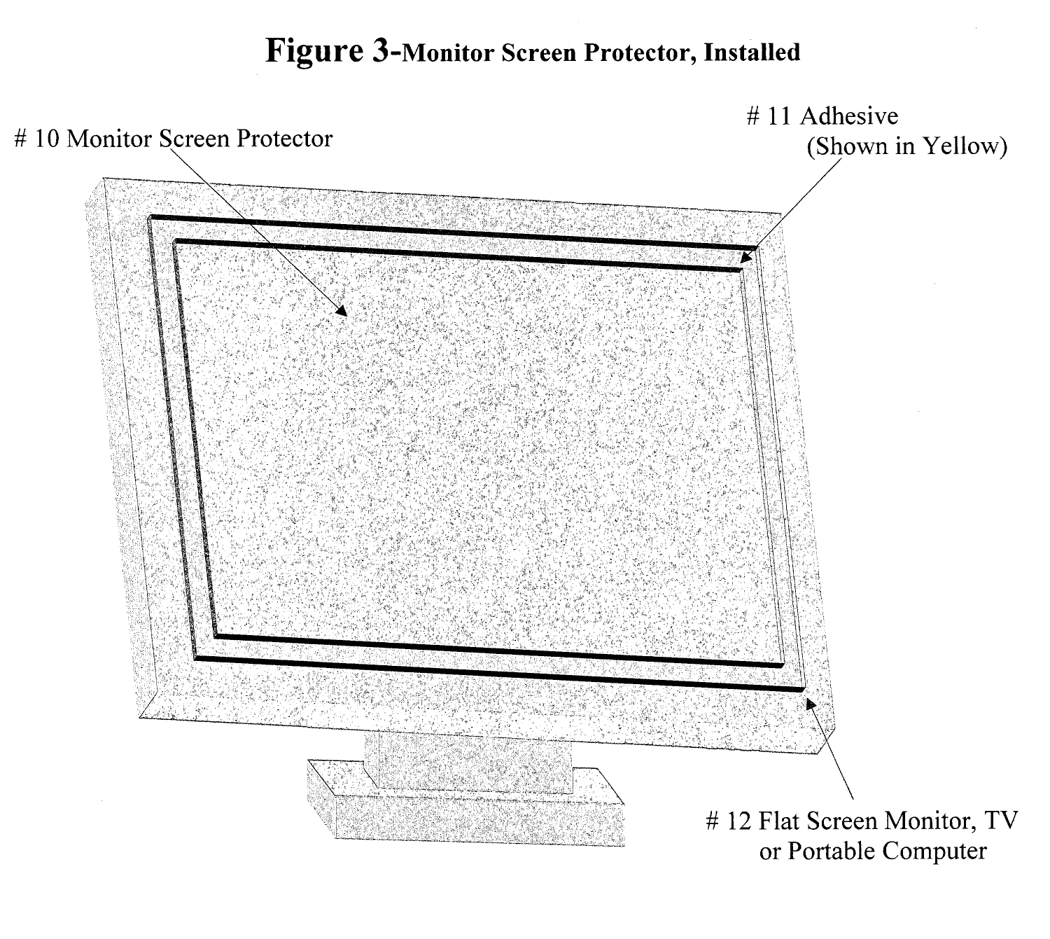

In accordance with the present invention, FIG. 2 (perspective view) shows the #10-Monitor Screen Protector with #11 Adhesive peeled and ready to attach to #12 Flat Screen Monitor, TV or Portable Computer Display Screen. To accomplish all the functions of the invention, there is shown in FIG. 3 (perspective view) the #10 Monitor Screen Protector permanently attached to #12 Flat Screen Monitor, TV or Portable Computer Display Screen by #11 Adhesive.

Alternative Embodiments

There are various possibilities with regard to the material that may be used in the manufacture of #10-Monitor Screen Protector. These include tinted glass, non-reflective glass, clear glass or various types of plastic. In addition the #11-Adhesive may be manually applied, mechanically applied, or not of the peel and stick application method.

Advantages

From the description above, a number of advantages of the Monitor Screen Protector become evident:

Protection from:

A) Vandalism

B) Impact

C) Dust, dirt and finger prints

D) Spills

E) Chemical spills

That Attaches:

A) Easily

B) Quickly

C) Without screws

D) Without bulky fasteners

E) Without clips

F) Without clamps

G) With Peel and Stick adhesive

### CONCLUSION

In conclusion the reader will see that the Monitor Screen Protector disclosed in this application will allow LCD Flat Screen Monitors, TV's and Portable Computer Display Screens to be used in hostile enviroments such as Educational, Public and Industrial arenas.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for the protection of LCD flat screen monitors, TV's and portable computer display screens comprising:
A monitor screen protector; and
An adhesive to attach the screen protector to the monitor.
